(19) United States
(12) Patent Application Publication
(10) Pub. No.: US 2026/0194671 A1
(43) Pub. Date: Jul. 9, 2026

(54) ADVANCED PERCEPTION SYSTEM FOR IN-SITU ENGINEERING ROCK MASS INFORMATION

(71) Applicant: Kunming University of Science and Technology, Kunming (CN)

(72) Inventors: Shunchuan WU, Kunming (CN); Zhiyuan XIA, Kunming (CN); Zechao ZHENG, Kunming (CN); Yingbo HUANG, Kunming (CN); Haiyong CHENG, Kunming (CN); Feng DAI, Kunming (CN); Chao WANG, Kunming (CN)

(73) Assignee: Kunming University of Science and Technology, Kunming (CN)

(21) Appl. No.: 19/434,057

(22) Filed: Dec. 29, 2025

(30) Foreign Application Priority Data
Jan. 9, 2025 (CN) 202510032851.2

(51) Int. Cl. G01V 1/09; G01V 1/143

(52) U.S. Cl. CPC G01V 1/09; G01V 1/143

(57) ABSTRACT

An advanced perception system for in-situ engineering rock mass information includes a perception tube, where the perception tube is of a tubular structure and is configured to extend into a hole to perceive and monitor the hole; the perception tube includes a dynamic excitation mechanism, an in-situ echo and elastic wave collection mechanism, an autonomous travelling mechanism, and a visual perception mechanism; the dynamic excitation mechanism includes a first driving unit and an excitation unit, and when abutting against an inner wall of the hole, the excitation unit strikes the inner wall of the hole to provide a dynamically-adjustable impact signal for the inner wall of the hole; and the autonomous travelling mechanism is configured to drive the perception tube to move in an axial direction of the hole.

### CROSS REFERENCE TO THE RELATED APPLICATIONS

This application is based upon and claims priority to Chinese Patent Application No. 202510032851.2, filed on Jan. 9, 2025, the entire contents of which are incorporated herein by reference.

### TECHNICAL FIELD

The present disclosure relates to the technical field of monitoring of geotechnical and deep underground space engineering, and in particular to an advanced perception system for in-situ engineering rock mass information.

### BACKGROUND

The accurate determination of mechanical parameters of rock masses, extremely-complex materials in nature, is crucial to stability analysis and design of the geotechnical and deep underground space engineering. In the engineering investigation, the common technical means includes a drilling method, a geophysical prospecting method, etc. The drilling method can intuitively and accurately reflect geological structures of in-situ engineering rock masses. The geophysical prospecting method is to monitor structural planes and properties of the rock masses as well as groundwater by emitting electromagnetic waves, elastic waves, or infrared radiation. However, these methods still have certain limitations in practical application.

Although the conventional drilling method can obtain intuitive information of the rock mass, the test index is relatively single, and the operation efficiency is low. Moreover, due to the complexity and heterogeneity of the rock mass, with a single drilling result, it is generally difficult to comprehensively reflect the overall mechanical properties of the rock mass. The geophysical prospecting method can provide some supplementary information, but its test result is rather qualitative and fails to satisfy the quantitative demand for mechanical parameters of engineering rock mass.

In addition, most existing test methods are only applicable to tests of surface rock masses after damage, deformation, or even failure, and thus have considerable difficulties in determining internal mechanical parameters of in-situ engineering rock masses. Moreover, separate measurement with various test technologies is cumbersome and complicated and can hardly ensure the accuracy and consistency of test results.

In view of the above, the inventor proposes an advanced perception system for in-situ engineering rock mass information to solve the above technical problems.

### SUMMARY

An objective of the present disclosure is to provide an advanced perception system for in-situ engineering rock mass information, so as to solve the problem that an existing device has a single test index, and thus fails to monitor and evaluate internal information of a rock mass comprehensively.

To achieve the above objective, the present disclosure employs the technical solution as follows:

The advanced perception system for in-situ engineering rock mass information is provided. The advanced perception system includes a perception tube, where the perception tube is of a tubular structure and is configured to extend into a hole to perceive and monitor the hole;

the perception tube includes a dynamic excitation mechanism, an in-situ echo and elastic wave collection mechanism, an autonomous travelling mechanism, and a visual perception mechanism;

the dynamic excitation mechanism includes a first driving unit and an excitation unit, where the first driving unit drives the excitation unit to extend or retract in a radial direction of the perception tube, and when abutting against an inner wall of the hole, the excitation unit strikes the inner wall of the hole to provide a dynamically-adjustable impact signal for the inner wall of the hole;

the in-situ echo and elastic wave collection mechanism includes a second driving unit and a geophone, where the second driving unit drives the geophone to extend or retract in the radial direction of the perception tube, and the geophone is configured to collect the impact signal generated by the excitation unit; and

the autonomous travelling mechanism is configured to drive the perception tube to move in an axial direction of the hole.

Further, the excitation unit includes an impact housing, an impact rod, and an electromagnetic excitation source, where the impact rod is arranged in the impact housing and is slidable in the impact housing, and one end of the electromagnetic excitation source extends into the impact housing to drive the impact rod to collide in the impact housing.

According to the above technical solution, when the system needs to generate an excitation signal, the electromagnetic excitation source starts to work, one end of the electromagnetic excitation source is positioned in the impact housing, and the impact rod is driven to slide in the impact housing under the action of the electromagnetic excitation source. In this process, the impact rod continuously collides with an inner wall of the impact housing to generate the excitation signal. Since the impact housing abuts against the inner wall of the hole, the energy generated through the collision is transmitted in a rock mass in a form of elastic waves, and then received by the in-situ echo and elastic wave collection mechanism.

Further, the electromagnetic excitation source includes an excitation source base and an excitation source housing arranged on the excitation source base, where an electromagnetic member and an armature are arranged in the excitation source housing, the electromagnetic member is arranged on the excitation source base, an elastic member is arranged between the electromagnetic member and the armature, and the elastic member has a tendency to drive the armature to move away from the electromagnetic member; and

a cavity is formed in the electromagnetic member, a cylinder fixed in the cavity is arranged in the cavity, and an alternating current coil and a direct current coil are wrapped around the cylinder.

Further, the first driving unit includes an upper excitation housing, a lower excitation housing, a first motor, a first connection member, and a first lead screw, where the upper excitation housing is detachably connected to the lower excitation housing, the first motor is arranged in the lower excitation housing, and an output shaft of the first motor is coaxially connected to the first lead screw; a first excitation sliding groove and a second excitation sliding groove are formed in the upper excitation housing, the first lead screw is rotatably connected in the first excitation sliding groove, and the excitation unit is slidably arranged in the second excitation sliding groove; and the first connection member is in threaded connection to the first lead screw, and the first connection member is connected to the excitation unit.

According to the above technical solution, the upper excitation housing and the lower excitation housing are combined in a detachable connection manner to form one closed space configured to accommodate and protect internal mechanical parts. The first motor is arranged in the lower excitation housing, and the output shaft of the first motor is coaxially connected to the first lead screw, so that rotary motion of the first motor can be converted into rotary motion of the lead screw. The first excitation sliding groove and the second excitation sliding groove are formed in the upper excitation housing, and the first excitation sliding groove and the second excitation sliding groove are configured to guide and restrict motion of the first lead screw and motion of the excitation unit. In use, the first motor drives the first lead screw to rotate when activated to rotate, the first lead screw drives the first connection member to move in an axis direction of the lead screw, and drives the excitation unit to abut against the inner wall of the hole, so that generated waves are transmitted to the inner wall of the hole.

Further, a top of the geophone is provided with a cambered patch, and an outer surface of the cambered patch is attached to the inner wall of the hole.

According to the above technical solution, the outer surface of the cambered patch is attached to the inner wall of the hole in a diameter direction, so that the cambered patch and the inner wall of the hole have a sufficient contact area and can be closely attached to each other. Accordingly, dynamic response full waveform information is collected and transmitted, and dynamic response features and dynamic mechanical parameters of the rock mass are appropriately reflected.

Further, the second driving unit includes an upper signal collection housing, a lower signal collection housing, a second motor, and a second lead screw, where the upper signal collection housing is detachably connected to the lower signal collection housing, the second motor is arranged in the lower signal collection housing, and an output shaft of the second motor is coaxially connected to the second lead screw; and

the upper signal collection housing is provided with a first signal collection groove and a second signal collection groove, the second lead screw is rotatably connected in the first signal collection groove, the geophone is slidably arranged in the second signal collection groove, a second connection member is in threaded connection to the second lead screw, and the second connection member is fixed to the geophone.

According to the above technical solution, the first signal collection groove is configured to accommodate and restrict rotation of the second lead screw, the second signal collection groove is configured to guide and restrict sliding of the geophone, and the second lead screw is rotatably connected in the first signal collection groove, so that rotation of the lead screw can be converted into linear motion in a groove direction. The geophone is configured to receive and collect the signal. The second motor drives the second lead screw to rotate when activated to rotate, and the rotation is transmitted to the second connection member through threaded connection, so that the connection member moves in an axis direction of the second lead screw. Movement of the second connection member drives the geophone to slide in the second signal collection groove. When the cambered patch above the geophone is attached to the inner wall of the hole, the second motor is deactivated, and the geophone collects the signal to work.

Further, the autonomous travelling mechanism includes a driving housing, a driving motor arranged in the driving housing, and at least two driving members, where the driving members are uniformly distributed on a circumferential surface of the driving housing, and the driving motor is configured to drive each driving member to rotate.

Further, each driving member includes a wheel carrier hinged on the driving housing, where one end of each wheel carrier is rotatably connected to a worm gear, the other end of each wheel carrier is rotatably connected to a caster, and a synchronous belt is connected between each worm gear and the caster;

an output shaft of the driving motor is connected to a worm, and each worm gear engages with the worm; and

a tension spring is arranged on each wheel carrier, each tension spring is connected to the driving housing, and each tension spring has a tendency to drive the caster to move away from the driving housing.

According to the above technical solution, the wheel carrier is a support for connecting the worm gear and the caster and is in hinged connection to the driving housing. The worm gear engages with the worm on the output shaft of the driving motor. The worm drives the worm gear to rotate when the driving motor rotates. The worm gear is connected to the caster through the synchronous belt. The worm gear drives the synchronous belt and the caster to rotate when rotating.

The driving motor drives the worm to rotate when activated. The worm drives the worm gear engaging with the worm to rotate when rotating. The worm gear drives the caster to rotate through the synchronous belt when rotating. Since the tension spring is arranged on the wheel carrier, the caster is subjected to certain elastic support when rotating, and the caster is in further contact with the inner wall of the hole and provides certain elastic support. Through the cooperative work of at least two driving members, the autonomous travelling mechanism can realize stable forward or backward movement in the hole. Accordingly, different positions inside the rock mass are monitored conveniently in real time, multi-point and multi-position tests are achieved, and qualitative test results are avoided.

Further, the visual perception mechanism includes a front camera and a lateral camera, where the front camera is arranged inside the perception tube, and the lateral camera is rotatably connected in the perception tube and is connected to the worm.

According to the above technical solution, the front camera can determine a fracture state of a rock mass of a hole wall in front of a drill hole and provide positioning information allowing the autonomous travelling mechanism to remain and perform in-situ echo and elastic wave tests in real time. The lateral camera is configured to collect annular continuous image information of the inner wall of the hole. The lateral camera is connected to the worm. The lateral camera can be driven to rotate through the worm while the perception tube can be driven to move. The camera is connected to the worm. With a single power source of the driving motor, the complexity of the system can be reduced, additional transmission mechanisms or complex wiring is avoided, and a failure rate is lowered.

Further, the advanced perception system for in-situ engineering rock mass information further includes a main control mechanism, where the main control mechanism includes a main control console, a control host arranged on the main control console, and a multi-channel data collection instrument, the control host is connected to the multi-channel data collection instrument, and the multi-channel data collection instrument is configured to be connected to the perception tube.

The present disclosure has the beneficial effects as follows:

According to the above technical solutions, the combination of the dynamic excitation mechanism and the in-situ echo and elastic wave collection mechanism realizes active excitation and signal collection of the inner wall of the hole. The first driving unit drives the excitation unit to extend in the radial direction, making the excitation unit closely abut against the inner wall of the hole and strike the inner wall of the hole to generate the dynamically-adjustable impact signal. In this process, the excitation unit serves as a signal emission source to emit sound waves that can precisely act on the rock mass to excite the elastic waves inside the rock mass. Then, the second driving unit drives the geophone to extend in the radial direction, making the geophone abut against the inner wall of the hole and collect the impact signal generated by the excitation unit and an echo signal reflected back. This combination improves the precision of signal collection and ensures the integrity and reliability of the signals.

In addition, with the participation of the autonomous travelling mechanism, the perception tube can move in the axial direction of the hole, realizing continuous monitoring of an entire hole. The autonomous travelling mechanism can drive the perception tube to move forward stably in the hole, ensuring that the excitation unit and the geophone can act on different positions of the hole in sequence. Thus, the monitoring efficiency is improved, and errors and potential safety hazards that are probably caused by manual operation are avoided.

Moreover, the visual perception mechanism is arranged to provide the intuitive monitoring means for the system. The front camera and the lateral camera can capture the image information inside the hole in real time, providing a clear view for the operator. Thus, abnormal conditions are found and processed in time, and the important reference basis is provided for subsequent engineering design and construction.

Finally, all the mechanisms are integrated and combined, and one complete and efficient monitoring and perception system is formed through precise design and coordination among all the mechanisms. Compared with the conventional drilling method and geophysical prospecting method design, the device has a compact structure, and thus solves the problem that the existing device has the single test index and fails to monitor and evaluate the internal information of the rock mass comprehensively.

Additional advantages, objectives, and features of the present disclosure will be set forth in the subsequent description to a particular extent, and to a certain extent, will be apparent to those skilled in the art based on the investigation and research of the following content, or can be taught by practice of the present disclosure. The objectives and other advantages of the present disclosure can be achieved and obtained through the particular implementations below.

### BRIEF DESCRIPTION OF THE DRAWINGS

FIG. 1 is an overall schematic structural diagram of an advanced perception system for in-situ engineering rock mass information of the present disclosure;

FIG. 2 is an exploded schematic structural diagram of a dynamic excitation mechanism of an advanced perception system for in-situ engineering rock mass information of the present disclosure;

FIG. 3 is a sectional view of an electromagnetic excitation source of an advanced perception system for in-situ engineering rock mass information of the present disclosure;

FIG. 4 is a schematic structural diagram of an in-situ echo and elastic wave collection mechanism of an advanced perception system for in-situ engineering rock mass information of the present disclosure;

FIG. 5 is a schematic structural diagram of an autonomous travelling mechanism of an advanced perception system for in-situ engineering rock mass information of the present disclosure;

FIG. 6 is a schematic structural diagram of a visual perception mechanism of an advanced perception system for in-situ engineering rock mass information of the present disclosure; and

FIG. 7 is a schematic structural diagram of a main control mechanism of an advanced perception system for in-situ engineering rock mass information of the present disclosure.

In the figures: perception tube 1, dynamic excitation mechanism 2, first driving unit 21, upper excitation housing 211, first excitation sliding groove 2111, second excitation sliding groove 2112, lower excitation housing 212, first motor 213, first connection member 214, first lead screw 215, excitation unit 22, impact housing 221, impact rod 222, electromagnetic excitation source 223, excitation source base 2231, excitation source housing 2232, electromagnetic member 2233, armature 2234, elastic member 2235, direct current coil 2236, alternating current coil 2237, in-situ echo and elastic wave collection mechanism 3, second driving unit 31, upper signal collection housing 311, first signal collection groove 3111, second signal collection groove 3112, lower signal collection housing 312, second motor 313, second lead screw 314, second connection member 315, geophone 32, cambered patch 321, autonomous travelling mechanism 4, driving motor 41, driving member 42, wheel carrier 421, worm gear 422, caster 423, synchronous belt 424, worm 43, tension spring 44, visual perception mechanism 5, front camera 51, lateral camera 52, main control mechanism 6, main control console 61, control host 62, and multi-channel data collection instrument 63.

### DETAILED DESCRIPTION OF THE EMBODIMENTS

Implementations of the present disclosure are described below with reference to the accompanying drawings and preferred embodiments. Other advantages and effects of the present disclosure will be readily understood by those skilled in the art from the contents disclosed in the description. The present disclosure can alternatively be implemented or applied in various other particular implementations, and various modifications or changes can be made to the details in the description based on different viewpoints and applications without departing from the spirit of the present disclosure. It should be understood that the preferred embodiments are merely to illustrate the present disclosure, and are not to limit the scope of protection of the present disclosure.

It should be noted that the figures provided in the following embodiments are merely to illustratively explain the basic concept of the present disclosure, and thus display only the components related to the present disclosure without being drawn according to the numbers, shapes, and sizes of the components in practical implementation. The forms, numbers, and proportions of the components in practical implementation can be changed randomly, and the layout of the components is probably more complex.

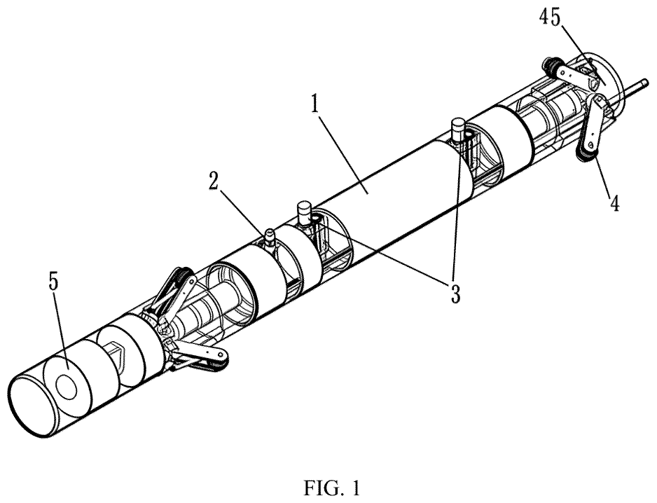

An advanced perception system for in-situ engineering rock mass information is provided in the embodiment. As shown in FIG. 1 to FIG. 7, the advanced perception system includes a perception tube 1, where the perception tube 1 is of an elongated tubular structure and is configured to extend into a hole of a rock mass to perceive and monitor the hole. As shown in FIG. 1, the perception tube 1 includes a dynamic excitation mechanism 2, an in-situ echo and elastic wave collection mechanism 3, an autonomous travelling mechanism 4, and a visual perception mechanism 5, where the visual perception mechanism 5 is arranged at a front end of the perception tube 1.

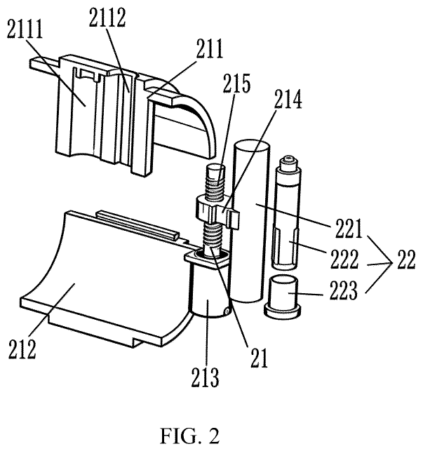

As shown in FIG. 1 and FIG. 2, the dynamic excitation mechanism 2 includes a first driving unit 21 and an excitation unit 22, where the first driving unit 21 drives the excitation unit 22 to extend or retract in a radial direction of the perception tube 1, and the excitation unit 22 strikes an inner wall of the hole to provide a dynamically-adjustable impact signal for the inner wall of the hole when working.

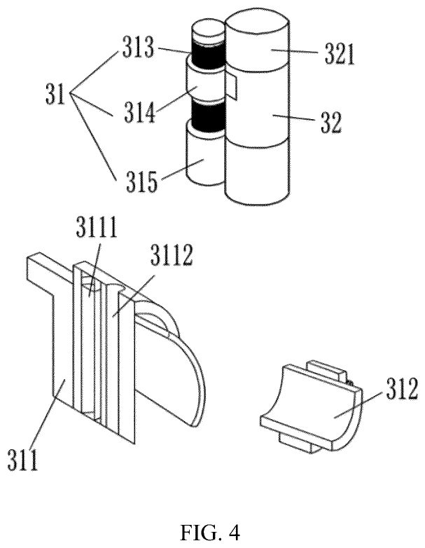

As shown in FIG. 4, the in-situ echo and elastic wave collection mechanism 3 includes a second driving unit 31 and a geophone 32, where the second driving unit 31 drives the geophone 32 to extend or retract in the radial direction of the perception tube 1, and the geophone 32 is configured to collect the impact signal generated by the excitation unit 22. The autonomous travelling mechanism 4 is configured to drive the perception tube 1 to move in an axial direction of the hole.

As a preferred implementation, as shown in FIG. 2, the excitation unit 22 includes an impact housing 221, an impact rod 222, and an electromagnetic excitation source 223, where the impact rod 222 is arranged in the impact housing 221 and is slidable in the impact housing 221, and one end of the electromagnetic excitation source 223 extends into the impact housing 221 to drive the impact rod 222 to collide in the impact housing 221. When the perception system needs to generate an excitation signal, the electromagnetic excitation source 223 starts to work and drives the impact rod 222 to slide in the impact housing 221. In this process, the impact rod 222 continuously collides with an inner wall of the impact housing 221 to generate a sound-wave excitation signal. When in use, since the impact housing 221 abuts against the inner wall of the hole of the rock mass, stress waves and elastic waves are generated through the collision, transmitted in the rock mass, and then received by the in-situ echo and elastic wave collection mechanism 3.

As a preferred implementation, the first driving unit 21 includes an upper excitation housing 211, a lower excitation housing 212, a first motor 213, a first connection member 214, and a first lead screw 215, where the upper excitation housing 211 is detachably connected to the lower excitation housing 212, and the upper excitation housing 211 and the lower excitation housing 212 are detachably combined through bolts or in a clamped manner to form one closed space configured to accommodate and protect internal mechanical parts; the first motor 213 is arranged in the lower excitation housing 212, and an output shaft 46 of the first motor 213 is coaxially connected to the first lead screw 215; a first excitation sliding groove 2111 and a second excitation sliding groove 2112 are formed in the upper excitation housing 211, the first lead screw 215 is rotatably connected in the first excitation sliding groove 2111, and the excitation unit 22 is slidably arranged in the second excitation sliding groove 2112; and the first connection member 214 is in threaded connection to the first lead screw 215, and the first connection member 214 is connected to the excitation unit 22. The first motor 213 is arranged in the lower excitation housing 212, and the output shaft 46 of the first motor is coaxially connected to the first lead screw 215. In this way, rotary motion of the first motor 213 can be converted into rotary motion of the lead screw. The first excitation sliding groove 2111 and the second excitation sliding groove 2112 are formed in the upper excitation housing 211, and the first excitation sliding groove 2111 and the second excitation sliding groove 2112 are configured to guide and restrict motion of the first lead screw 215 and motion of the excitation unit 22. In use, when the first motor 213 is activated to rotate, and drives the first lead screw 215 to rotate, the first lead screw 215 drives the first connection member 214 to move in an axial direction of the lead screw, so as to drive the excitation unit 22 to rise until the excitation unit 22 abuts against the inner wall of the hole of the rock mass. Thus, the generated stress waves and elastic waves can be transmitted to the inner wall of the hole.

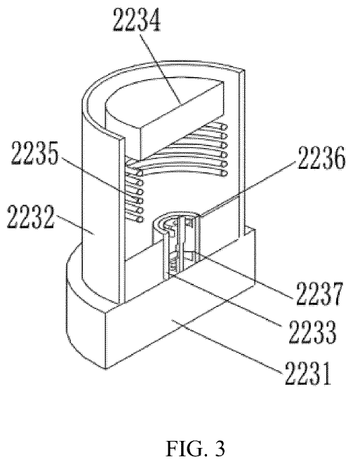

Further, as shown in FIG. 3, the electromagnetic excitation source 223 includes an excitation source base 2231 and an excitation source housing 2232 arranged on the excitation source base 2231, where an electromagnetic member 2233 and an armature 2234 are arranged in the excitation source housing 2232, the electromagnetic member 2233 is arranged on the excitation source base 2231, an elastic member 2235 is arranged between the electromagnetic member 2233 and the armature 2234, and the elastic member 2235 has a tendency to drive the armature 2234 to move away from the electromagnetic member 2233. In the embodiment, the elastic member 2235 is preferably a spring. A cavity is formed in the electromagnetic member 2233, a cylinder fixed in the cavity is arranged in the cavity, an alternating current coil 2237 and a direct current coil 2236 are wrapped around the cylinder, and the alternating current coil 2237 is arranged below the direct current coil 2236. A magnetic field generated by the direct current coil 2236 is relatively stable and low in rate of change, so that electromagnetic interference generated is relatively low. By arranging the alternating current coil 2237 below the direct current coil 2236, the influence of electromagnetic interference generated when the alternating current coil 2237 works on the generated stress waves and elastic waves can be reduced. The alternating current coil 2237 and the direct current coil 2236 may be energized separately or simultaneously when the excitation source works. In a case where the direct current coil 2236 is energized separately, when a current flows through the direct current coil, one constant magnetic field is generated between the cylinder and the armature 2234. Thus, one constant electromagnetic attractive force is applied to the armature 2234 to attempt to pull the armature 2234 towards the electromagnetic member 2233. However, in the presence of the elastic member 2235 (such as the spring), it generates an opposite force on the armature 2234, making the armature have a tendency to move away from the electromagnetic member 2233. Thus, under the action of the direct current coil 2236, the armature 2234 is in a relatively stable equilibrium position and is subjected to one constant electromagnetic force. In the embodiment, the excitation effect is achieved by connecting and disconnecting the current of the direct current coil 2236 and the current of the alternating current coil 2237. For the alternating current coil 2237, when flowing through the alternating current coil, a separate alternating current generates one alternating magnetic field between the cylinder and the armature 2234, and the alternating magnetic field generates one alternating electromagnetic attractive force on the armature 2234. When application of a high-frequency excitation signal is required, an excitation force can be generated through the alternating current coil 2237, so that the armature 2234 reciprocates under the joint action of the electromagnetic force and the elastic force to achieve the excitation effect. When the direct current coil 2236 and the alternating current coil 2237 work simultaneously, the armature 2234 is subjected to one superimposed or attenuated electromagnetic force that encompasses a constant component (generated by the direct current coil 2236) and an alternating component (generated by the alternating current coil 2237). Thus, a motion track of the armature 2234 and a magnitude of an excitation force can be precisely controlled by adjusting magnitudes and phases of a direct current and an alternating current as required. Further, the impact rod 222 is driven to strike the excitation source housing 2232 and transmit striking to the inner wall of the hole of the rock mass through the excitation source housing 2232. Thus, the excitation effect is achieved, and motion of the armature 2234 becomes more complex and diverse, which facilitates perception and monitoring research. For ease of review and understanding, when the direct current coil 2236 and the alternating current coil 2237 work simultaneously, the armature 2234 is subjected to one superimposed or attenuated electromagnetic force. When flowing through the coil, the direct current generates one constant magnetic field around the cylinder. A direction of the magnetic field depends on a direction of the current and follows the right-hand screw rule. When energized, the alternating current coil 2237 generates one alternating magnetic field around the cylinder, and a direction and a magnitude of the magnetic field varies with the cycle of the alternating current. Under specific conditions, for example, when the alternating current reaches a (positive or negative) peak value, the magnetic field generated and the magnetic field generated by the direct current are probably opposite in direction and similar in magnitude. In this case, the two magnetic fields cancel each other, resulting in attenuation or even disappearance of a synthesized magnetic field around the cylinder. Similarly, the two magnetic fields may be superimposed on each other, resulting in superposition and enhancement of the synthesized magnetic field around the cylinder. The above two cases can be achieved by controlling the current directions, magnitudes, relative position relations, and environments of the two coils. Accordingly, the technical demand of various rock mass tests is satisfied, and the mechanical parameters of the in-situ engineering rock mass are truly reflected.

Further, a top of the geophone 32 is provided with a cambered patch 321, and an outer surface of the cambered patch 321 is attached to the inner wall of the hole. The cambered patch 321 and the inner wall of the hole have a sufficient contact area. Thus, dynamic response full waveform information is collected and transmitted, and dynamic response features and dynamic mechanical parameters of the rock mass are appropriately reflected.

As a preferred implementation, as shown in FIG. 4, the second driving unit 31 includes an upper signal collection housing 311, a lower signal collection housing 312, a second motor 313, and a second lead screw 314, where the upper signal collection housing 311 is detachably connected to the lower signal collection housing 312 in a snap fit manner or a threaded connection manner; the second motor 313 is arranged in the lower signal collection housing 312, and an output shaft 46 of the second motor 313 is coaxially connected to the second lead screw 314; and the upper signal collection housing 311 is provided with a first signal collection groove 3111 and a second signal collection groove 3112, the second lead screw 314 is rotatably connected in the first signal collection groove 3111, the geophone 32 is slidably arranged in the second signal collection groove 3112, a second connection member 315 is in threaded connection to the second lead screw 314, and the other end of the second connection member 315 is fixed to the geophone 32. The first signal collection groove 3111 is configured to accommodate and restrict the position of the second lead screw 314, the second signal collection groove 3112 is configured to guide and restrict sliding of the geophone 32, and the geophone 32 is configured to receive and collect the signal. When activated to rotate, the second motor 313 drives the second lead screw 314 to rotate and transmits rotation to the second connection member 315 through threaded connection, so that the second connection member 315 moves in an axis direction of the second lead screw 314. Movement of the second connection member 315 drives the geophone 32 to slide in the second signal collection groove 3112. When the cambered patch 321 above the geophone 32 is attached to the inner wall of the hole, the second motor 313 is deactivated, and the geophone 32 starts to collect the signal to work.

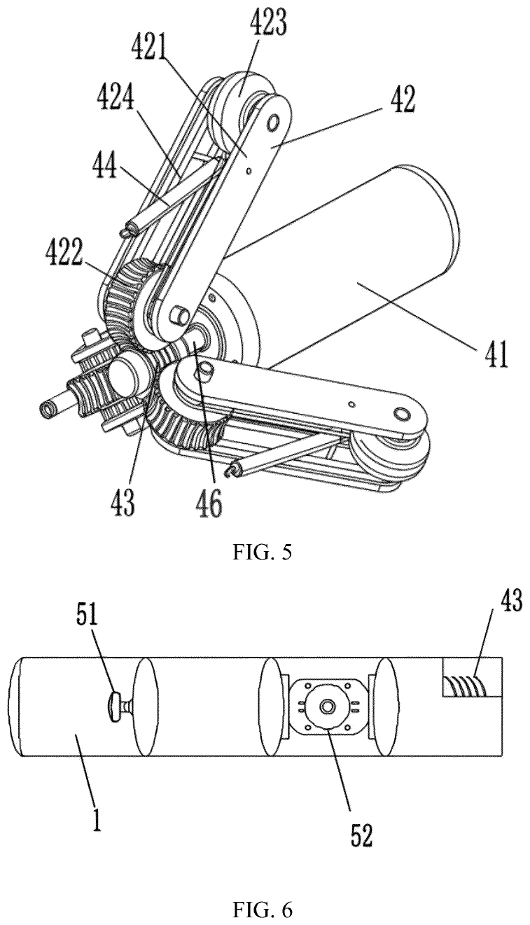

As a preferred implementation, as shown in FIG. 1 and FIG. 5, the autonomous travelling mechanism 4 includes a driving housing 45, a driving motor 41 arranged in the driving housing 45, and at least two driving members 42, where the driving members 42 are uniformly distributed on a circumferential surface of the driving housing 45, and the driving motor 41 is configured to drive each driving member 42 to rotate. In the embodiment, three driving members 42 are provided on the outer periphery of the driving housing 45 uniformly.

Further, as shown in FIG. 5, each driving member 42 includes a wheel carrier 421 hinged on the driving housing 45, where one end of each wheel carrier 421 is rotatably connected to a worm gear 422, the other end of each wheel carrier 421 is rotatably connected to a caster 423, a synchronous belt 424 is connected between each worm gear 422 and the caster 423, and each worm gear 422 drives the caster 423 to rotate through the synchronous belt 424 when rotating.

An output shaft 46 of the driving motor 41 is connected to a worm 43, and each worm gear 422 engages with the worm 43; and a tension spring 44 is arranged on each wheel carrier 421, each tension spring 44 is connected to the driving housing 45, and each tension spring 44 has a tendency to drive the caster 423 to move away from the driving housing 45 (or each tension spring 44 has a tendency to drive the caster 423 to extend outwards).

In the embodiment, the wheel carrier 421 is a support for connecting each worm gear 422 and the caster 423 and is in hinged connection to the driving housing 45. Each worm gear 422 engages with the worm 43 on the output shaft 46 of the driving motor 41. When the driving motor 41 rotates, the worm 43 drives each worm gear 422 to rotate and further drives the caster 423 to rotate through the synchronous belt 424. Since the tension spring 44 is arranged on the wheel carrier 421, the caster 423 is subjected to certain elastic support when rotating, so as to make further contact with the inner wall of the hole. In the embodiment, the three driving members 42 cooperatively work, and the driving motor 41 is a forward and reverse rotating motor, so that the autonomous travelling mechanism 4 can move autonomously in the hole of the rock mass to perceive comprehensive and detailed information of the rock mass. Accordingly, the efficiency of information perception is improved. By controlling the motion track and speed of the travelling mechanism, it is ensured that the perception tube 1 performs accurate measurement and monitoring at key positions, so that more accurate and comprehensive information of the rock mass is acquired, multi-point and multi-position tests are achieved, and qualitative test results are avoided.

As a preferred implementation, as shown in FIG. 1 and FIG. 6, the visual perception mechanism 5 includes a front camera 51 and a lateral camera 52, where the front camera 51 is arranged inside the perception tube 1, and the lateral camera 52 is rotatably connected in the perception tube 1 and is connected to the worm 43. The front camera 51 can determine a fracture state of the hole of the rock mass in front of a drill hole and provide positioning information allowing the autonomous travelling mechanism 4 to remain and perform in-situ echo and elastic wave tests in real time. The lateral camera 52 is configured to collect annular continuous image information of the inner wall of the hole. The lateral camera 52 is connected to the worm 43. The driving motor 41 can also drive the lateral camera 52 to rotate through the worm 43 while driving the perception tube 1 to move. The camera is connected to the worm 43. With a single power source of the driving motor 41, the complexity of the system can be reduced, additional transmission mechanisms or complex wiring is avoided, and a failure rate is lowered.

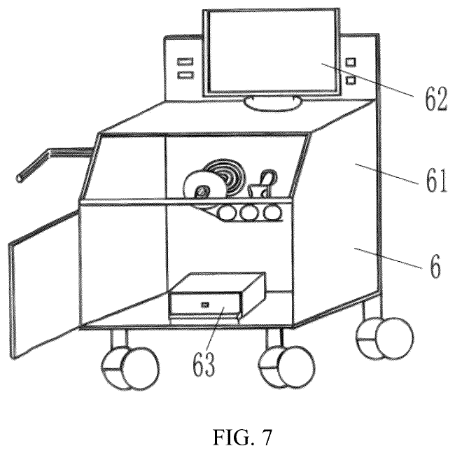

As a preferred implementation, as shown in FIG. 7, the advanced perception system further includes a main control mechanism 6, where the main control mechanism 6 includes a main control console 61, a control host 62 arranged on the main control console 61, and a multi-channel data collection instrument 63, the control host 62 is connected to the multi-channel data collection instrument 63, and the multi-channel data collection instrument 63 is configured to be connected to the perception tube 1. In the embodiment, the control host 62 acts as the center of operation and control, coordinates and controls the whole system through software programs, and is responsible for sending instructions to the perception tube 1 to control movement of the perception tube 1 and work of each mechanism. Moreover, the control host 62 also receives data from the multi-channel data collection instrument 63 and performs processing and analysis. The multi-channel data collection instrument 63 is responsible for data collection and transmission. The multi-channel data collection instrument 63 has a powerful data collection capability and can simultaneously collect data returned by multiple mechanisms. After processed, the collected data are transmitted to the control host 62 for further analysis and processing. Accordingly, the internal information of the rock mass is comprehensively monitored, analyzed, and evaluated.

In the embodiment, the in-situ echo and elastic wave collection mechanism 3 mainly depends on the impact signal generated by the excitation unit 22. When the impact rod 222 of the excitation unit 22 applies an impact force to the rock mass through the impact housing 221, the stress waves and the elastic waves are generated in the rock mass. These stress waves are propagated in the rock mass and reflected back in a case of encountering interfaces (such as lithological changes and fractures) to form echo signals. These echo signals and elastic wave signals are captured by the high-sensitivity geophone 32 and digitized in conjunction with the multi-channel data collection instrument 63. By analyzing the arrival time, amplitude, frequency, etc. of the echo signals, the mechanical parameters such as the elastic modulus, the Poisson's ratio, the internal structure, and the defect information of the rock mass can be inferred. The elastoplastic properties, the damage degree, the fracture development, etc. of the rock mass can be further acquired by analyzing these waveform information.

The above embodiments are merely the preferred embodiments for fully illustrating the present disclosure, and do not limit the scope of protection of the present disclosure. The equivalent substitutions or variations made by those skilled in the art based on the present disclosure fall within the scope of protection of the present disclosure.

What is claimed is:

1. An advanced perception system for in-situ engineering rock mass information, comprising a perception tube, wherein
the perception tube is of a tubular structure and is configured to extend into a hole to perceive and monitor the hole;
the perception tube comprises a dynamic excitation mechanism, an in-situ echo and elastic wave collection mechanism, an autonomous travelling mechanism, and a visual perception mechanism;
the dynamic excitation mechanism comprises a first driving unit and an excitation unit, wherein the first driving unit drives the excitation unit to extend or retract in a radial direction of the perception tube, and the excitation unit strikes an inner wall of the hole to provide a dynamically-adjustable impact signal for the inner wall of the hole when working;
the in-situ echo and elastic wave collection mechanism comprises a second driving unit and a geophone, wherein the second driving unit drives the geophone to extend or retract in the radial direction of the perception tube, and the geophone is configured to collect the impact signal generated by the excitation unit;
the autonomous travelling mechanism is configured to drive the perception tube to move in an axial direction of the hole;
the excitation unit comprises an impact housing, an impact rod, and an electromagnetic excitation source, wherein the impact rod is arranged in the impact housing and is slidable in the impact housing, and one end of the electromagnetic excitation source extends into the impact housing to drive the impact rod to collide in the impact housing;
the electromagnetic excitation source comprises an excitation source base and an excitation source housing arranged on the excitation source base, wherein an electromagnetic member and an armature are arranged in the excitation source housing, the electromagnetic member is arranged on the excitation source base, an elastic member is arranged between the electromagnetic member and the armature, and the elastic member has a tendency to drive the armature to move away from the electromagnetic member;
a cavity is formed in the electromagnetic member, a cylinder fixed in the cavity is arranged in the cavity, an alternating current coil and a direct current coil are wrapped around the cylinder, and the alternating current coil and the direct current coil are energized separately or simultaneously;
the alternating current coil is arranged below the direct current coil;
the armature is subjected to a superimposed or attenuated electromagnetic force when the direct current coil and the alternating current coil work simultaneously, wherein the superimposed or attenuated electromagnetic force encompasses a constant component and an alternating component; a motion track of the armature and a magnitude of an excitation force are precisely controlled by adjusting magnitudes and phases of a direct current and an alternating current as required, so as to drive the impact rod to strike the excitation source housing and transmit striking to the inner wall of the hole of a rock mass through the excitation source housing to make motion of the armature become more complex and diverse;
the autonomous travelling mechanism comprises a driving housing, a driving motor arranged in the driving housing, and at least two driving members, wherein the driving members are uniformly distributed on a circumferential surface of the driving housing, and the driving motor is configured to drive each driving member to rotate;
each driving member comprises a wheel carrier hinged on the driving housing, wherein one end of each wheel carrier is rotatably connected to a worm gear, the other end of each wheel carrier is rotatably connected to a caster, and a synchronous belt is connected between each worm gear and the caster;
an output shaft of the driving motor is connected to a worm, and each worm gear engages with the worm;
a tension spring is arranged on each wheel carrier, each tension spring is connected to the driving housing, and each tension spring has a tendency to drive the caster to move away from the driving housing; and
the visual perception mechanism comprises a front camera and a lateral camera, wherein the front camera is arranged inside the perception tube, and the lateral camera is rotatably connected in the perception tube and is connected to the worm; and the driving motor drives the lateral camera to rotate through the worm while driving the perception tube to move.

2. The advanced perception system for the in-situ engineering rock mass information according to claim 1, wherein the first driving unit comprises an upper excitation housing, a lower excitation housing, a first motor, a first connection member, and a first lead screw, wherein the upper excitation housing is detachably connected to the lower excitation housing, the first motor is arranged in the lower excitation housing, and an output shaft of the first motor is coaxially connected to the first lead screw; a first excitation sliding groove and a second excitation sliding groove are formed in the upper excitation housing, the first lead screw is rotatably connected in the first excitation sliding groove, and the excitation unit is slidably arranged in the second excitation sliding groove; and the first connection member is in threaded connection to the first lead screw, and the first connection member is connected to the excitation unit.

3. The advanced perception system for the in-situ engineering rock mass information according to claim 2, wherein a top of the geophone is provided with a cambered patch, and an outer surface of the cambered patch is attached to the inner wall of the hole.

4. The advanced perception system for the in-situ engineering rock mass information according to claim 3, wherein the second driving unit comprises an upper signal collection housing, a lower signal collection housing, a second motor, and a second lead screw, wherein the upper signal collection housing is detachably connected to the lower signal collection housing, the second motor is arranged in the lower signal collection housing, and an output shaft of the second motor is coaxially connected to the second lead screw; and
the upper signal collection housing is provided with a first signal collection groove and a second signal collection groove, the second lead screw is rotatably connected in the first signal collection groove, the geophone is slidably arranged in the second signal collection groove, a second connection member is in threaded connection to the second lead screw, and the second connection member is fixed to the geophone.

5. The advanced perception system for the in-situ engineering rock mass information according to claim 1, further comprising a main control mechanism, wherein the main control mechanism comprises a main control console, a control host arranged on the main control console, and a multi-channel data collection instrument, wherein the control host is connected to the multi-channel data collection instrument, and the multi-channel data collection instrument is configured to be connected to the perception tube.
